(19) United States
(12) Patent Application Publication
(10) Pub. No.: US 2006/0036646 A1
(43) Pub. Date: Feb. 16, 2006

(54) Method and apparatus for classifying files

(75) Inventor: Lu-Kang Mao, Taipei City (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 11/058,188

(22) Filed: Feb. 16, 2005

(30) Foreign Application Priority Data
Aug. 6, 2004 (TW) 093123704

(51) Int. Cl. G06F 17/00

(52) U.S. Cl. 707/104.1

(57) ABSTRACT

An apparatus and method for classifying files are disclosed. The steps of the method include providing a plurality of files containing file information. A classifying parameter in the file information for classifying the files is set to classify the files. A plurality of file groups is divided from the files. Also, all files in one file group contain the same classifying parameter.

### BACKGROUND OF THE INVENTION

1. Field of the Invention

The present invention relates to a method and an apparatus for classifying files, and more particularly to the method and the apparatus for classifying files by means of setting a classifying parameter.

2. Description of the Prior Art

The quantity of a storage device increases so fast that anyone could store large numbers of data or message in the type of electrical files in the storage device, such as a hard disk, a memory card and an optical disk. However, a lot of numbers of the electrical files also causes a difficulty for users to search the wanted data later. Although the present software may supply a particular column or a keyword to search and sort the homophylic files, the user still needs a lot of time to find the wanted file while the amount of the homophylic files are too many.

For example, the quantity of the memory card used in the digital camera becomes much bigger and bigger. The image files recorded at several travels with different time are stored in the memory card. Even though the image files are transmitted to a hard disk equipped in the computer or recorded on the optical disk, the image files are still without classifying. It is a very trouble and wasting time thing for users to search the particular image file.

When computers or consumer electronics are equipped with hard disks, such as DVD players, users may store many image files produced by many digital cameras in the hard disk. The image files stored in the hard disk may be without classifying. Even though the image files may be sorted according time presently, it still needs to browse a image file after a image file in turn or browse in random jumps in order to find the image file recorded at a particular travel.

Accordingly, the presently electronic products, such as computers, digital cameras or DVD players, are not equipped with the function of finding the target files in high speed so as to waste the user's time for searching files. The present invention supplies a method and apparatus for classifying files to solve above-mentioned questions.

### SUMMARY OF THE INVENTION

Accordingly, a method and apparatus for classifying files are provided for users in order to solve the question that users could not quickly find the target data among a large numbers of data.

In order to achieve above-mentioned purposes, a method for classifying files is disclosed. The steps of the method include providing a plurality of files containing file information. A classifying parameter selected from the file information is set to classify the files. A plurality of file groups is divided from the files according to the classifying parameter.

In order to achieve above-mentioned purposes, an apparatus for classifying files is disclosed. The apparatus includes a storage device configured to store a plurality of files containing file information. An input device is configured to set a classifying parameter selected from the file information. A processor is configured to divide the files into a plurality of file groups according to the classifying parameter and procedure of classifying files.

### BRIEF DESCRIPTION OF THE DRAWINGS

The present invention can be best understood through the following description and accompanying drawings wherein:

FIG. 1 is a flow chart of the preferred embodiment of the present invention.

FIG. 2 is a block diagram showing the general structure of an apparatus according to the embodiment.

### DESCRIPTION OF THE PREFERRED EMBODIMENT

Some embodiments of the present invention have detailed descriptions below. However, except for the detailed descriptions, the present invention can have a broad use in other embodiments, and the scope of the present invention can not be defined by this preferred embodiment, but by the appended claims.

The present invention could be applied in the area of consumer electronics, without limitation, such as a digital camera, a DVD player, a Digital Video, a camera phone, a computer and so on.

For example, the memory card in the digital camera contains pictures recording seven travel destinations within different days, herein 10 sheets of pictures taken in the first travel destination to position A, 90 sheets of pictures taken in the second travel destination to position B, 50 sheets of pictures taken in the third travel destination to position C, 50 sheets of pictures taken in the fourth travel destination to position D, 40 sheets of pictures taken in the fifth travel destination to position E, 30 sheets of pictures taken in the sixth travel destination to position F and 30 sheets of pictures taken in the seventh travel destination to position G. There are in total 300 sheets of pictures taken in the seven travels.

Generally, each one of pictures is an image file and each image file has file information. The file information includes file size, file type, set-up time (year/month/day/hour/minute/second), modification time and so on. In order to solve the question that users could not quickly search the target data among a large number of data, the present invention sets up a classifying file program in the design of the digital camera. The present invention sets up a classifying parameter to divide all image files into a plurality of file groups. For example, the day of the set-up time among the file information is selected to be the classifying parameter. Thus, the procedure of classifying files could divide 300 sheets of image files into seven file groups according to the classifying parameter. Herein the first file group contains 10 sheets of image files; the second file group contains 90 sheets of image files; the third file group contains 50 sheets of image files; the fourth file group contains 50 sheets of image files; the fifth file group contains 40 sheets of image files; the sixth file group contains 30 sheets of image files; and the seventh file group contains 30 sheets of image files.

After dividing 300 sheets of image files into seven file groups, the user could see the first picture of one of the seven file groups selectively. That is to say, after seeing the first picture of the first file group. If it is not the picture wanted, the user could directly see the first picture of the second file group without browsing any one of the pictures of the first file group by use of a control key or an option on the digital camera. This method could avoid wasting time to find the wanted file in the traditional way of browsing each picture after each picture in turn.

Besides, the preferred embodiment of the present invention could also adopt a way of browsing the pictures as thumbnails. The first pictures of each of file groups could be displayed in the same frame on the display device of the digital camera in this way. The time of file information for the first picture of each file group is most early among the others of the file group, without limitation, it also may be the most lately or intermediate among the others of the file group.

Additionally, if the user wants to continue to search for the picture taken near noon at position D, the procedure of classifying files is repeated in this file group again. For example, the hour of the set-up time among the file information could be selected to be the classifying parameter. Thus, the procedure of classifying files could divide 50 image files into several file groups according to the classifying parameter. The user could get a picture near the noon quickly by use of seeing the first pictures of these file groups.

The above-mentioned embodiment mainly checks the pictures stored in the memory card from the display device of the digital camera. The present invention is not limited in this embodiment. Another application is that the image files stored in the memory card of the digital camera are transmitted into the hard disk of the computer, so the image files stored in the hard disk could be searched by use of the program of the computer. Similarly, the procedure of classifying files could be recorded on the design of the program, so the user could get the wanted image file by use of the classifying parameter according to the file information contained in the image file. Therefore, the application of the present invention is not limited in any kind of storage mediums and display devices. Besides, the present invention not only searches the image files but also searches the text files, video files and so on.

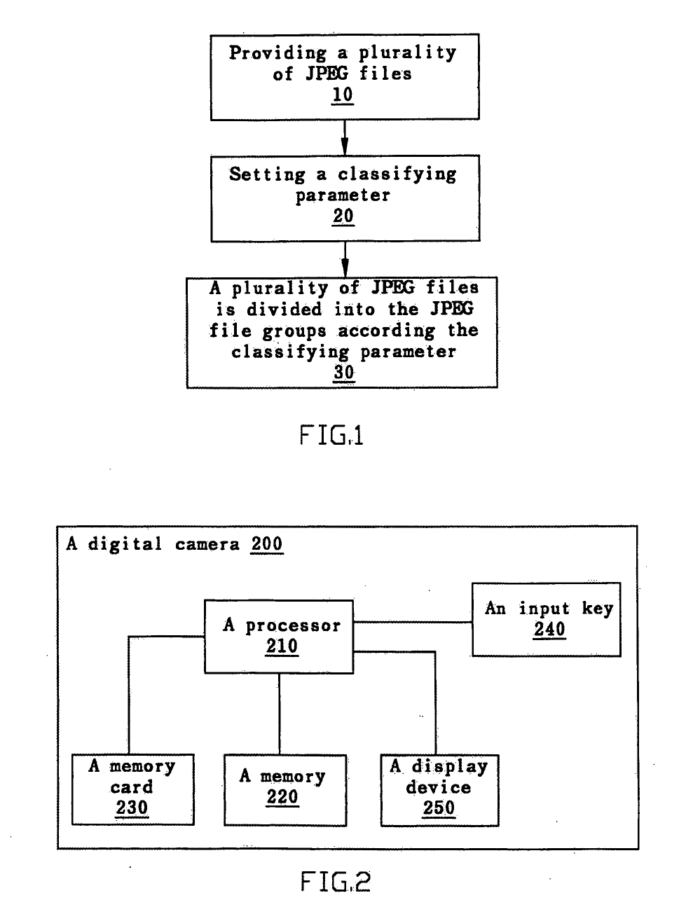

FIG. 1 is a flow chart of the preferred embodiment of the present invention. A method for classifying JPEG files by use of the classifying parameter according to the set-up time among the file information is disclosed. The step of the flow chart includes providing a plurality of JPEG files (step 10). These JPEG files may be stored in a storage device, such as a memory card. The storage device may be equipped internally in the electrical device or externally connected to the electrical device or another way. In the other embodiment, JPEG files may be stored in the hard disk of the computer. Moreover, the set-up time could be used as a classifying parameter for JPEG files in the embodiment. But the present invention is not limited in the embodiment, other file information, such as file size, file type, modification time and so on, could be applied in the present invention.

All of the JPEG files contain the file information. Next, the set-up time is set to be a classifying parameter (step 20). For example, the day of the set-up time is selected to be a classifying parameter. A plurality of JPEG files is divided into the JPEG file groups according to the classifying parameter selected from the file information (step 30). Thus, a large numbers of JPEG files could be divided into a plurality of JPEG file groups with the different set-up time.

Because the plurality of file groups are divided from the JPEG files by use of the classifying parameter, all files in one of the plurality of file groups contain the same classifying parameter. Besides, the so-called “group” here may be identified or stored by use of an appropriate label. While labeling or storing, there is no change to the original JPEG file. An index may be used without limitation in the present invention.

Next, when the user wants to browse or search the image file in the display device, such as a representative file of the first JPEG file group has been shown in the frame of the liquid crystal display device. It only needs to use a control key or an option for the user to display the representative file of the next JPEG file group. In another embodiment, the representative files of all the JPEG file groups could be shown in the same frame of the liquid crystal display device at the same time. The user may use the control key or option key to see the image file among any one of the JPEG file groups.

Moreover, after the user selects any one of the JPEG file groups, the procedure of the step 10 to step 30 could be repeated again. New classifying parameter is set to divide the JPEG files contained in any one of the JPEG file groups. For example, the hour of the set-up time is selected as the classifying parameter. Thus, the procedure of classifying files could divide the JPEG files into several file groups according to the new classifying parameter. One of characteristic of the present invention is to automatically set the classifying parameter to classify the files into a plurality of file groups. The user does not need to set up file folders and move files manually. Besides, the control key or option could be used to execute a “jump action”. Here the so-called “jump action” could directly help the user see the other file of the other file group by skipping the files of the present file group.

FIG. 2 is a block diagram showing the general structure of an apparatus according to the embodiment. The apparatus may be a digital camera 200, which includes a processor 210, a memory 220, a memory card 230, an input key 240 and a display device 250. First, a program about classifying files according to the above-mentioned method is recorded into the memory 220. The processor 210 could classify the image files stored in the memory card 230 according the program. When the user wants to find a particular image file, the input key 240 of the digital camera 200 is used to set a classifying parameter, such as the set-up time of the file information. The processor 210 could execute a procedure of classifying files to classify the image files stored in the memory card 230 according to the classifying parameter. Next, the representative files (or the first image files) of the different image file groups are shown in the display device 250. Surely, the procedure of classifying files could be applied in the computer to classify the files stored in the storage device of the computer.

Above said preferred embodiment is only used to illustrate the present invention, not intended to limit the scope thereof. Many modifications of the preferred embodiment can be made without departing from the spirit of the present invention.

What is claimed is:

1. A method for classifying files, said method comprising:
providing a plurality of files, wherein each of said files contains file information;
setting a classifying parameter from said file information; and
classifying said files into a plurality of file groups according to said classifying parameter.

2. The method of claim 1, wherein each of said files is selected from the group consisting of image files, video files and text files.

3. The method of claim 1, wherein said file information is selected from the group consisting of set-up time, modification time, file size and file type.

4. The method of claim 1, further comprising showing at least one file of the first file group.

5. The method of claim 1, further comprising showing at least one file of each of said file groups.

6. The method of claim 1, wherein said files of each of said file groups contains the same said classifying parameter.

7. Apparatus for classifying files, said apparatus comprising:
a storage device configured to store a plurality of files, wherein each of said files contains file information;
an input device configured to set a classifying parameter from said file information; and
a processor configured to classify said files into a plurality of file groups according to said classifying parameter and a procedure of classifying files.

8. The apparatus of claim 7, further comprising a display device configured to show at least one file of the first file group.

9. The apparatus of claim 7, further comprising a display device configured to show at least one file of each of said file groups.

10. The apparatus of claim 7, wherein said file information is selected from the group consisting of set-up time, modification time, file size and file type.

11. The apparatus of claim 7, wherein said files of each of said file groups contains the same said classifying parameter.
